(19) United States
(12) Patent Application Publication
(10) Pub. No.: US 2005/0141218 A1
(43) Pub. Date: Jun. 30, 2005

(54) Energy-saving foot board capable of producing sound and light by vibration

(76) Inventor: Ching-Tien Tsai, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/751,558

(22) Filed: Dec. 31, 2003

(51) Int. Cl. F21S 2/00

(52) U.S. Cl. 362/227

(57) ABSTRACT

A foot board includes a main body, a plurality of light emitting members, a controller, and a trigger. Thus, the light emitting members emit light outward from the main body when a person's one foot steps on the main body, thereby greatly enhancing the aesthetic quality of the foot board.

### BACKGROUND OF THE INVENTION

1. Field of the Invention

The present invention relates to a foot board, and more particularly to an energy-saving foot board capable of producing sound and light by vibration so as to provide an optical or audio effect.

2. Description of the Related Art

Usually, the indoor or outdoor ground of a building often adopts an ornamental floor board to provide a decorative effect. The ornamental floor board has various colors and patterns so as to enhance the outer appearance of the ground of the building. However, the conventional ornamental floor board has a flat surface without providing an additional function, such as the optical or audio effect, thereby limiting the versatility of the conventional ornamental floor board.

### SUMMARY OF THE INVENTION

The primary objective of the present invention is to provide an energy-saving foot board capable of producing sound and light by vibration so as to provide an optical or audio effect.

Another objective of the present invention is to provide a foot board, wherein the light emitting members emit light outward from the main body when a person's one foot steps on the main body, thereby greatly enhancing the aesthetic quality of the foot board.

A further objective of the present invention is to provide a foot board, wherein the program control circuit of the controller transmits a signal to drive the audio drive circuit of the sound emitter, so that the sound emitter emits sound outward, thereby enhancing the amusement effect of the foot board.

In accordance with the present invention, there is provided a foot board, comprising:
a main body;
a plurality of light emitting members mounted on the main body;
a controller mounted on the main body and having a first side electrically connected to the light emitting members by conducting wires and a second side electrically connected to a power supply; and
a trigger mounted on the main body and connected to the controller to control operation of the controller.

Further benefits and advantages of the present invention will become apparent after a careful reading of the detailed description with appropriate reference to the accompanying drawings.

### BRIEF DESCRIPTION OF THE DRAWINGS

FIG. 1 is a partially exploded perspective view of a foot board in accordance with the preferred embodiment of the present invention;

FIG. 2 is an exploded perspective assembly view of a foot board in accordance with the preferred embodiment of the present invention;

FIG. 3 is a top plan cross-sectional assembly view of the foot board taken along line 3-3 as shown in FIG. 1;

FIG. 4 is a schematic operational view of the foot board as shown in FIG. 1 in use;

### DETAILED DESCRIPTION OF THE INVENTION

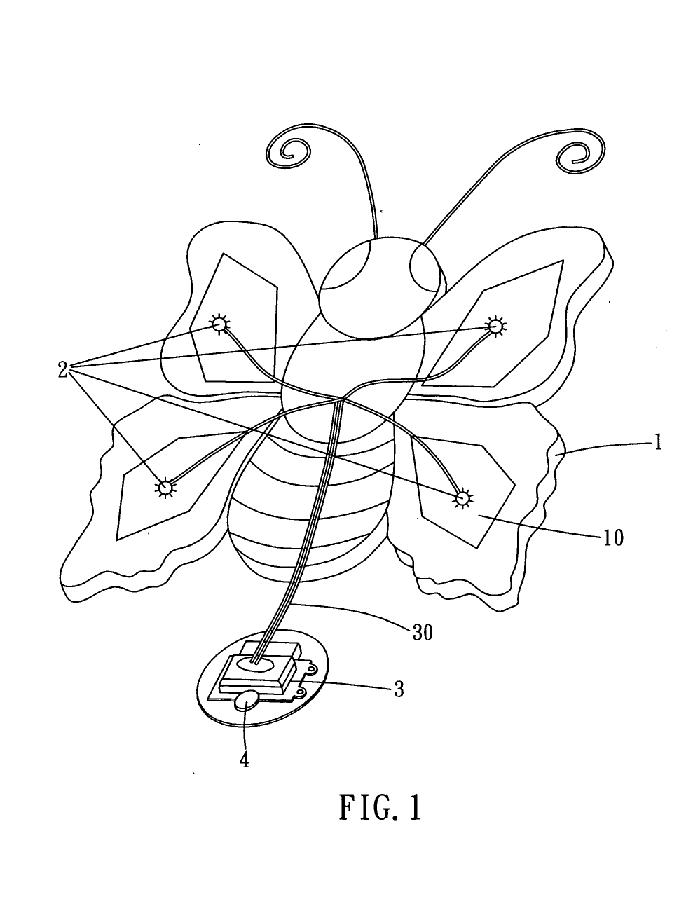

Referring to the drawings and initially to FIGS. 1-3, a foot board in accordance with the preferred embodiment of the present invention comprises a main body 1, a plurality of light emitting members 2 mounted on the main body 1, a controller 3 mounted on the main body 1 and having a first side electrically connected to the light emitting members 2 by conducting wires 30 and a second side electrically connected to a power supply, and a trigger 4 mounted on the main body 1 and connected to the controller 3 to control operation of the controller 3.

Preferably, each of the light emitting members 2 is a light emitting diode (LED). The main body 1 has a plurality of transparent portions 10 each corresponding to a respective one of the light emitting members 2.

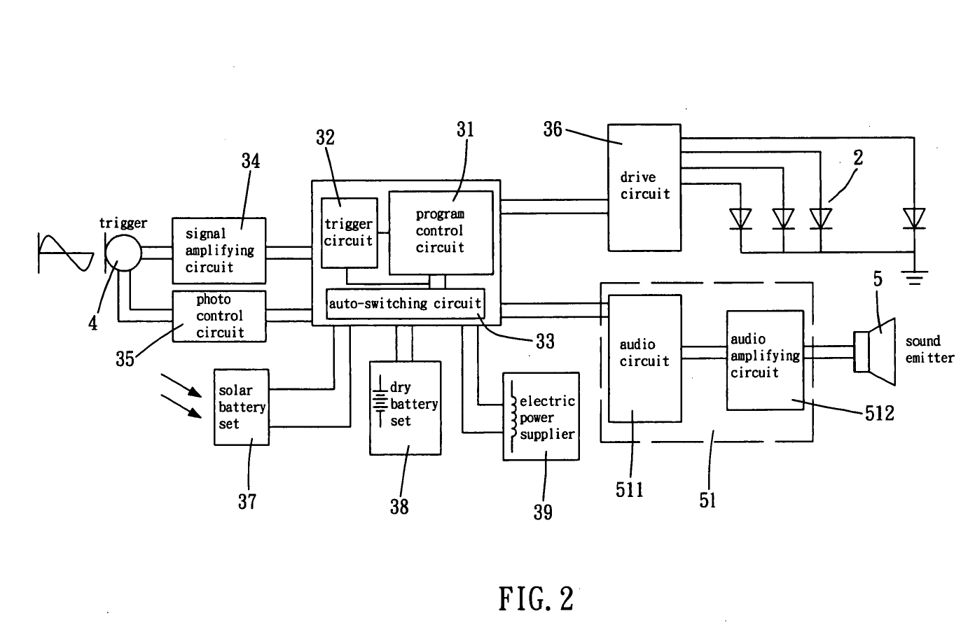

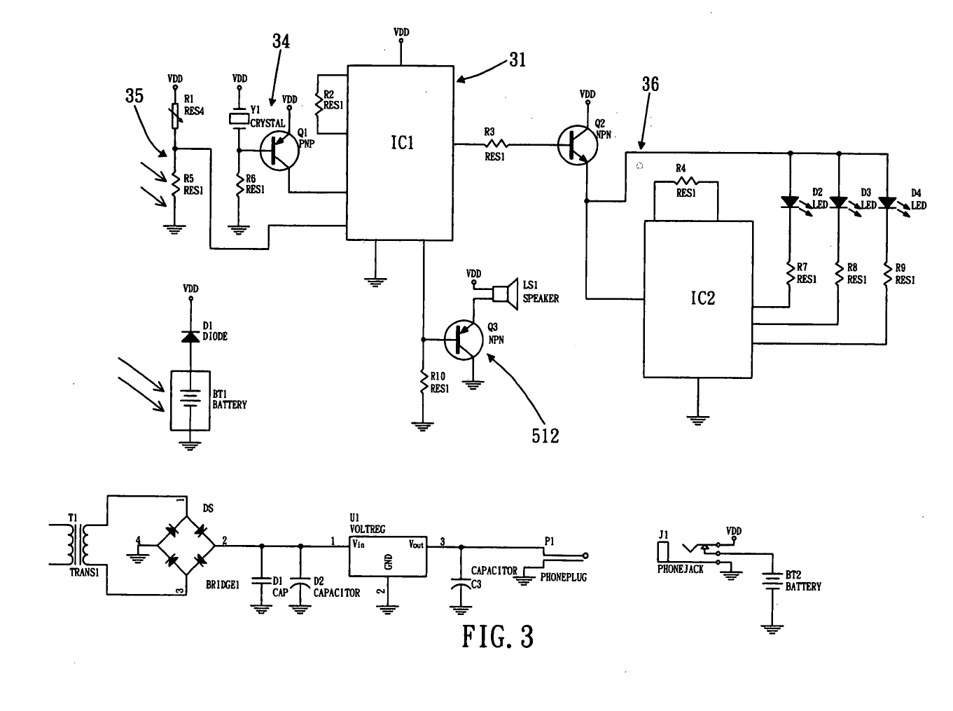

As shown in FIGS. 2 and 3, the controller 3 includes a program control circuit 31, a trigger circuit 32 connected to the program control circuit 31, and an auto-switching circuit 33 having a first side connected to the program control circuit 31 and a second side connected to the power supply. Preferably, the power supply contains a solar battery set 37, a dry battery set 38 and an electric power supplier 39.

The controller 3 further includes a signal amplifying circuit 34 connected between the trigger circuit 32 and the trigger 4. The signal amplifying circuit 34 includes a PNP transistor Q2. Thus, the trigger circuit 32 of the controller 3 is triggered by the trigger 4 through the signal amplifying circuit 34.

The controller 3 further includes a photo control circuit 35 connected between the trigger circuit 32 and the trigger 4. The photo control circuit 35 is a photo sensitive control member. Thus, when the light source of the foot board is disposed at a sufficient state, the trigger circuit 32 of the controller 3 is not triggered by the trigger 4 by control of the photo control circuit 35 so as to save the electrical energy.

The controller 3 further includes a drive circuit 36 connected between the program control circuit 31 and the light emitting members 2. The drive circuit 36 includes a NPN transistor Q3 and an integrated circuit IC2 (CDT3143). Thus, the drive circuit 36 drives the light emitting members 2 to emit light according to the predetermined working mode.

The foot board further comprises a sound emitter 5 mounted on the main body 1 and connected to the controller 3 by an audio drive circuit 51. The audio drive circuit 51 includes an audio circuit 511, and an audio amplifying circuit 512. Thus, the audio signal is amplified by the NPN transistor Q4 of the audio amplifying circuit 512 and is then transmitted to the sound emitter 5, so that the sound emitter 5 emits sound outward.

In practice, when a person's one foot steps on the main body 1, a vibration is produced to trigger and start the trigger 4 which emits a signal to trigger the trigger circuit 32 of the controller 3 which connects the light emitting members 2 to the power supply, so that the light emitting members 2 emit light outward according to the predetermined working mode so as to light successively or to blink. At this time, the controller 3 connects the sound emitter 5, so that the sound emitter 5 emits sound outward.

In operation, the signal transmitted from the trigger 4 is amplified by the PNP transistor Q2 of the signal amplifying circuit 34. Then, the amplified signal is transmitted into the trigger circuit 32, so that the central integrated circuit IC1 (CDT3143) of the program control circuit 31 of the controller 3 performs a level transfer to enter the working state to drive the auto-switching circuit 33 to connect the power supply. At the same time, the program control circuit 31 transmit a signal to drive the drive circuit 36, so that the drive circuit 36 drives the light emitting members 2 to emit light according to the predetermined working mode.

Accordingly, the light emitting members 2 emit light outward from the main body 1 when a person's one foot steps on the main body 1, thereby greatly enhancing the aesthetic quality of the foot board. In addition, the program control circuit 31 transmits a signal to drive the audio drive circuit 51 of the sound emitter 5, so that the sound emitter 5 emits sound outward, thereby enhancing the amusement effect of the foot board.

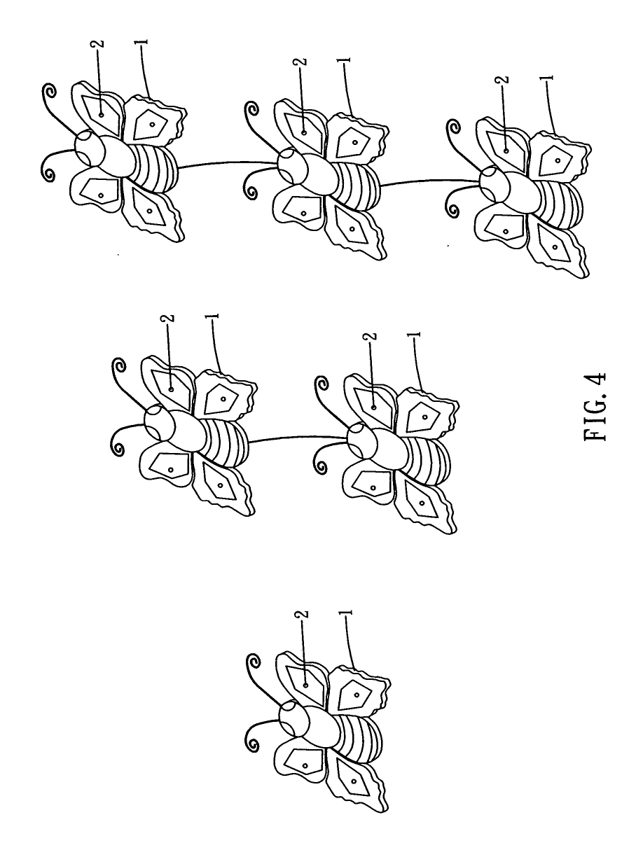

Referring to FIG. 4, a plurality of foot boards are serially connected with each other to enhance the versatility of the foot board.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A foot board, comprising:
a main body;
a plurality of light emitting members mounted on the main body;
a controller mounted on the main body and having a first side electrically connected to the light emitting members by conducting wires and a second side electrically connected to a power supply; and
a trigger mounted on the main body and connected to the controller to control operation of the controller.

2. The foot board in accordance with claim 1, wherein the controller includes a program control circuit, a trigger circuit connected to the program control circuit, and an auto-switching circuit having a first side connected to the program control circuit and a second side connected to the power supply.

3. The foot board in accordance with claim 1, wherein the controller further includes a signal amplifying circuit connected between the trigger circuit and the trigger.

4. The foot board in accordance with claim 1, wherein the controller further includes a photo control circuit connected between the trigger circuit and the trigger, so that when a light source of the foot board is disposed at a sufficient state, the trigger circuit of the controller is not triggered by the trigger by control of the photo control circuit so as to save the electrical energy.

5. The foot board in accordance with claim 4, wherein the photo control circuit is a photo sensitive control member.

6. The foot board in accordance with claim 1, wherein the controller further includes a drive circuit connected between the program control circuit and the light emitting members.

7. The foot board in accordance with claim 1, further comprising a sound emitter mounted on the main body and connected to the controller by an audio drive circuit.

8. The foot board in accordance with claim 7, wherein the audio drive circuit includes an audio circuit, and an audio amplifying circuit.

9. The foot board in accordance with claim 1, wherein the power supply contains a solar battery set.

10. The foot board in accordance with claim 1, wherein the power supply contains a dry battery set.

11. The foot board in accordance with claim 1, wherein the power supply contains an electric power supplier.

12. The foot board in accordance with claim 1, wherein each of the light emitting members is a light emitting diode (LED).

13. The foot board in accordance with claim 1, wherein the main body has a plurality of transparent portions each corresponding to a respective one of the light emitting members.
